(19) United States
(12) Patent Application Publication
(10) Pub. No.: US 2004/0031541 A1
(43) Pub. Date: Feb. 19, 2004

(54) Corner chisel device for doors and the like

(76) Inventor: Steven V. Gomez, Denver, CO (US)

Correspondence Address: Emerry L. Tracy, P.O. Box 1518, Boulder, CO, 80306-1518, US

(21) Appl. No.: 10/223,278

(22) Filed: Aug. 19, 2002

(51) Int. Cl. B27M 3/00; B27M 3/34

(52) U.S. Cl. 144/27

(57) ABSTRACT

A corner chisel device for removing unchiseled corners of a door hardware receiving area on a door is provided. The corner chisel device comprises a handle and a mounting base secured to the handle. A first chisel assembly is secured to the mounting base. A second chisel assembly secured to the mounting base wherein the first chisel assembly and the second chisel assembly are selectively and separably operable to remove the corners of the receiving area.

### BACKGROUND OF THE INVENTION

1. Field of the Invention

This invention relates generally to a corner chisel for doors and the like and, more particularly, the invention relates to a corner chisel for easily and accurately chiseling a portion of a door for receiving door hardware, i.e., the hinge plate of a hinge assembly.

2. Description of the Prior Art

Prior to mounting a door within a door frame, a portion of the door along the door edge must be removed for mounting the hinge assemblies to allow the hinge plates of the hinge assemblies to be flush with the edge of the door. The hinge assemblies typically include two hinge plates with the door side hinge plate being mounted to the edge of the door and the other hinge plate being mounted to the door frame. Typically, this hinge-receiving door portion for receiving the door side hinge plate is removed with a router or other adequate tool. Unfortunately, while these tools allow removal of the material, these tools are is not capable of removing a substantially rectanigular portion of the door and the operator must then manually chisel the corners of the door portion such that a rectangular-shaped the hinge plate fits accordingly.

In the past, tools have been designed in an attempt to remove the corners of the door portion in an easy and rapid manner. These tools are difficult to properly align and none of these tools can accurately remove the unchiseled corners in an easy and rapid manner. In addition, these conventional corner removing tools are difficult to align within the removed door portion and many times the operator is required several attempts to properly and accurately remove the corner portion for the door side hinge plate to fit therein.

Accordingly, there exists a need for a corner chisel device for doors and the like which easily and rapidly removes the unchiseled corner portion of a door for receiving the hinge plate. Additionally, a need exists for a cornier chisel device for doors and the like which can be accurately aligned for removing the unchiseled corner portion of a door for receiving the hinge plate. Furthermore, there exists a need for a corner chisel device for doors and the like which can easily be handled by an operator thereby minimizing potential injury.

### SUMMARY

The present invention is a corner chisel device for removing unchiseled corners of a door hardware receiving area on a door. The corner chisel device comprises a handle and a mounting base secured to the handle. A first chisel assembly is secured to the mounting base. A second chisel assembly secured to the mounting base wherein the first chisel assembly and the second chisel assembly are selectively and separably operable to remove the corners of the receiving area.

In addition, the present invention includes a system for chiseling a material from a recess having an edge. The system comprises a first chisel base having a first side and a second side and a second chisel base having a first side and a second side. A first chisel portion is associated with the first chisel base and selectively movable to remove material. A second chisel portion is associated with the second chisel base and selectively movable to remove material wherein at least three of the sides selected from the first side of the first chisel base, the second side of the first chisel base, the first side of the second chisel base, and the second side of the second chisel base are contactable with the edge of the recess for aligning either the first chisel portion or the second chisel portion prior to removing the material.

The present invention further includes a method for removing the unchiseled corners of a door hardware receiving area on a door. The method comprises aligning a chisel portion within the door hardware receiving area with at least a three-point contact with the door hardware receiving area.

### BRIEF DESCRIPTION OF THE DRAWINGS

FIG. 1 is a front perspective view illustrating the corner chisel device for doors and the like, constructed in accordance with the present invention;

FIG. 2 is a rear perspective view illustrating the corner chisel device for doors and the like, constructed in accordance with the present invention;

FIG. 3 is an exploded view illustrating the corner chisel device for doors and the like, constructed in accordance with the present invention;

FIG. 4 is an elevational side view illustrating a door prior to using the corner chisel device of the present invention; and

FIG. 5 is an elevational side view illustrating the door subsequent to using the corner chisel device of the present invention.

### DETAILED DESCRIPTION OF THE PREFERRED EMBODIMENTS

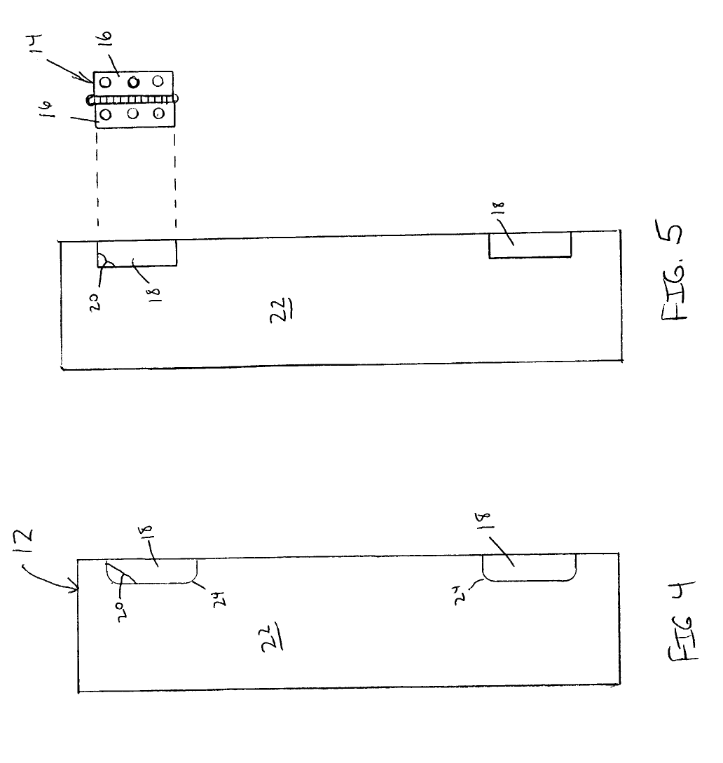

As illustrated in FIGS. 13, the present invention is a corner chisel device, indicated generally at 10, for chiseling doors 12 (See, FIGS. 4 and 5) and the like to receive hinges 14 (See, FIGS. 4 and 5) and other door hardware. The hinge has at least one hinge plate 16 for securement to the door 12. After a door 12 is constructed, as illustrated in FIG. 4, a hinge plate receiving recess 1 8 having a recess edge 20 is formed in at least one edge 22 of the door 12 for receiving the door side hinge plate 16 of the hinge 14. The corner chisel device 10 of the present invention is designed for removing the corners 24 of the hinge plate receiving recess 18 in the door 12, as illustrated in FIG. 5, after the hinge plate receiving recess 18 has been formed.

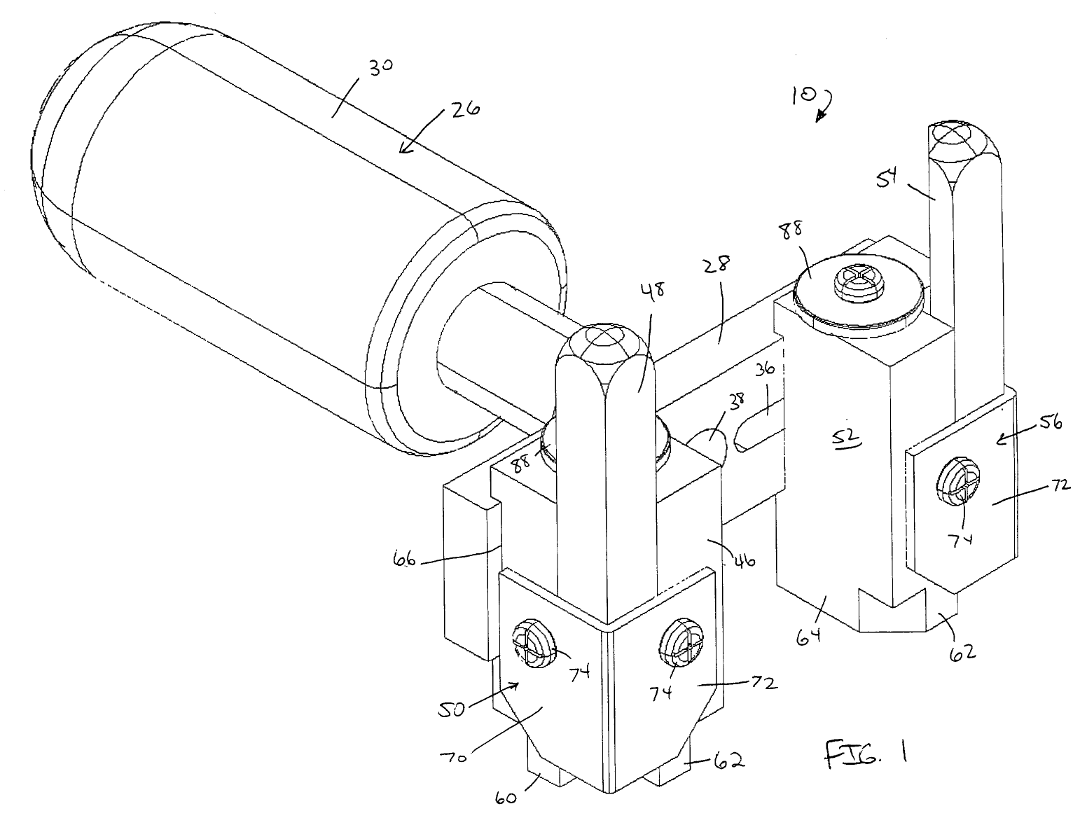

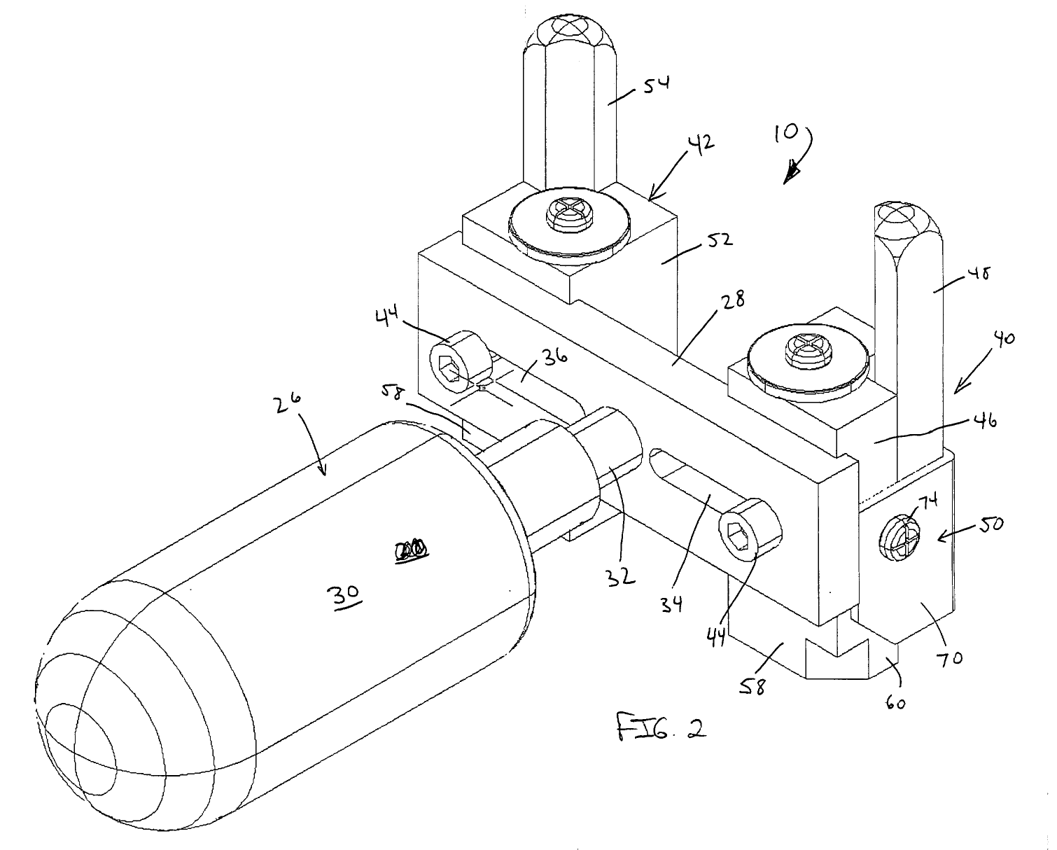

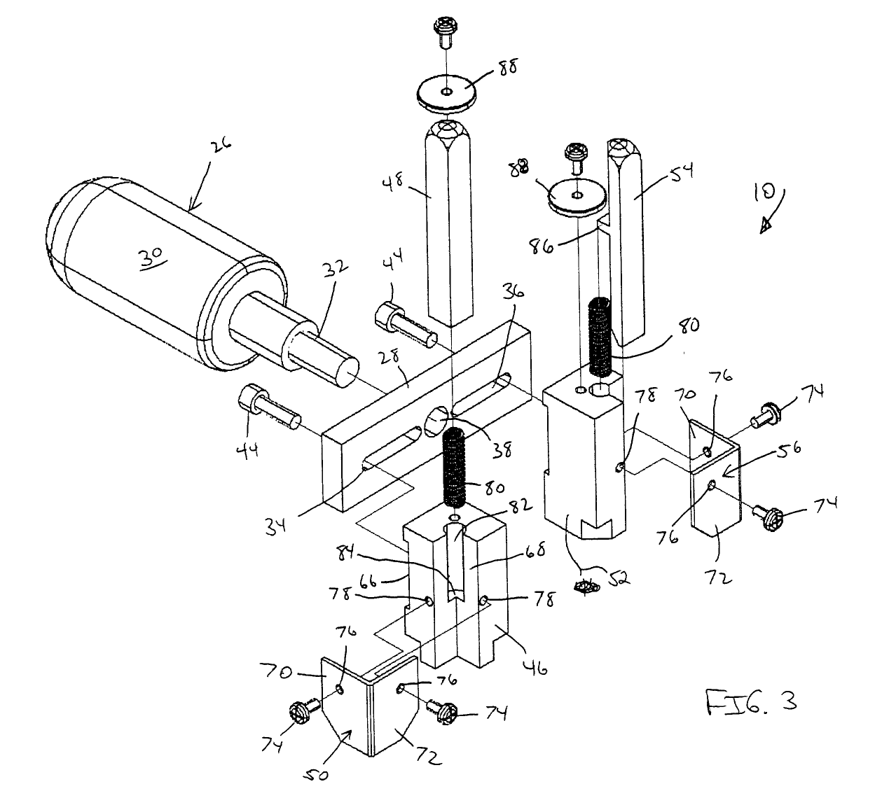

Referring to FIGS. 1-3, the corner chisel device 10 of the present invention includes a handle 26 and a mounting plate 28. The handle 26 includes a gripping portion 30 and a mounting projection 32 extending from the gripping portion 30. The mounting plate 28 includes a first slot 34, a second slot 36, and a handle-receiving aperture 38. The mounting projection 32 of the handle 26 is receivable within the handle-receiving aperture 38 of the mounting plate 28 and secured therein. Securement of the handle 26 to the mounting plate 28 can be accomplished by various means including, but not limited to, friction, adhesives, screws, bolts, welding, etc.

While the handle 26 is shown extending from the mounting plate 28 in a particular direction, it is within the scope of the present invention for the handle 26 to extend from the top of the mounting plate 28 or from another side of the mounting plate 28, as desired by the manufacturer or operator. In these instances, the handle-receiving aperture 38 is formed in a different position on the mounting plate 28 than as shown.

The corner chisel device 10 of the present invention further includes a first chisel assembly 40 and a second chisel assembly 42. The first chisel assembly 40 and the second chisel assembly 42 are mounted to the first slot 34 and the second slot 36, respectively, of the mounting plate 28 by a screw 44 or the like extending through each of the first slot 34 and the second slot 36 into a threaded aperture (not shown) in the first chisel assembly 40 and the second chisel assembly 42.

The first chisel assembly 40 includes a first chisel base 46, a first chisel portion 48, and first securement device 50 and the second chisel assembly 42 includes a second chisel base 52, a second chisel portion 54, and second securement device 56. Both the first chisel base 46 and the second chisel base 52 have a first side wall 58, a second side wall 60 opposite the first side wall 58, a third side wall 62 between the first side wall 58 and the second side wall 60, and a fourth side wall 64 opposite the third side wall 62 between the first side 58 wall and the second side wall 60.

The first side wall 58 has a groove 66 formed therein for receiving the mounting plate 28. The groove 66 limits the longitudinal movement of the first chisel assembly 40 and the second chisel assembly 42 relative to the mounting plate 28 while allowing the first chisel assembly 40 and the second chisel assembly 42 to move along the first slot 34 and the second slot 36, respectively. The first chisel assembly 40 and the second chisel assembly 42 can be adjusted and releasably secured along the length of the mounting plate 28 depending on the size of the hinge plate receiving recess 18.

A chisel portion receiving area 68 is formed at the intersection of the second side wall 60 and the third side wall 62 of each chisel base 46, 52 for slidably receiving each chisel portion 48, 54. The first securement device 50 and the second securement device 56 are preferably an L-shaped securement device having a first portion 70 and a second portion 72. The first portion 70 of each securement device 50, 56 is preferably secured to the second side wall 60 and the second portion 72 of each securement device 50, 56 is preferably secured to the third side wall 62 of the first chisel base 46 and the second chisel base 52, respectively, by screws 74 or the like. The L-shaped securement devices 50, 56 allow longitudinal movement of the first and second chisel portions 48, 54 while maintaining the first and second chisel portions 48, 54 adjacent the first and second chisel bases 46, 52, respectively. Aligned apertures 76 in the first and second securement devices 50, 56 and threaded apertures 78 in the first and second chisel bases 46, 52 receive the screws 74 to secure the first and second securement devices 50, 56 to the first and second chisel bases 46, 52, respectively. The first and second chisel portions 48, 54 are slidably secured within the chisel portion receiving area 68 between the first and second chisel bases 46, 52 and the first and second securement devices 50, 56, respectively.

The corner chisel device 10 of the present invention further includes biasing means, such as a spring 80, cooperating with each chisel portion 48, 54 to bias each chisel portion 48, 54 in a substantially upward direction. A spring-receiving slot 82 is formed in the first and second chisel bases 46, 52 for receiving the spring 80. The spring 80 is biased within the spring-receiving slot 82 between a shelf 84 formed in the spring-receiving slot 86 and a ledge 86 formed on each of the first and second chisel portions 48, 54. A washer mechanism 88 secured to each chisel base 46, 52 is contactable with the ledge 86 limiting the upward travel extent of the first and second chisel portions 48, 54.

The first chisel portion 48 and the second chisel portion 54 each include a sharpened chisel point 84. The chisel points 84 are designed to penetrate the unchiseled corners 24 of the hinge plate receiving recess 18 to remove the unchiseled corners 24 from the door 12 during operation of the corner chisel device 10.

Operation of the corner chisel device 10 of the present invention will now be described in detail. As understood by a person skilled in the art, the below described operation of the corner chisel device 10 is merely one embodiment of operation and other methods of operation are within the scope of the present invention.

After hinge plate receiving recess 18 has been formed in the door 12 for receiving the hinge plate 16 of the hinge 14, the corners 24 of the hinge, plate receiving recess 18 are removable with the corner chisel device 10. To remove the corners 24, the second side wall 60 and the third side wall 62 of the first chisel base 46 of the first chisel assembly 40 and the second side wall 60 of the second chisel base 52 of the second chisel assembly 42 are aligned along the recess edge 20 with the first chisel portion 48 and/or the second chisel portion 54 directly above the corner 24 to be removed. The chisel portion(s) 48, 54 is then driven in a generally downward direction, e.g., with a hammer or mallet, against the bias of the spring 80 to cause the chisel point(s) 84 to penetrate and remove one or both of the corners 24.

The corner chisel device 10 of the present invention is then slidably moved until the second side wall 60 and the third side wall 62 of the second chisel base 52 of the second chisel assembly 42 and the second side wall 60 of the first chisel base 46 of the first chisel assembly 40 are aligned along the recess edge 20 directly above the other unchiseled corner 24 to be removed. Once again, the chisel portion(s) 48, 54 is driven in a generally downward direction against the bias of the spring 80 to cause the chisel point(s) 84 to remove one or both of the unchiseled corners 24.

The corner chisel device 10 of the present invention provides a three-point or four-point contact within the hinge plate receiving recess 18 along the recess edge 20. The three-point or four-point contact allows the operator to quickly align the corner chisel device 10 in the proper location and accurately remove the corners 24 from the hinge plate receiving recess 18.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A corner chisel device for removing unchiseled corners of a door hardware receiving area on a door, the corner chisel device comprising:
a handle;
a mounting base secured to the handle;
a first chisel assembly secured to the mounting base; and
a second chisel assembly secured to the mounting base;
wherein the first chisel assembly and the second chisel assembly are selectively and separably operable to remove the corners of the receiving area.

2. The corner chisel device of claim I wherein the first chisel assembly and the second chisel assembly are adjustably slidably secured to the mounting base.

3. The corner chisel device of claim 1 wherein the first chisel assembly and the second chisel assembly each include a chisel base, a chisel portion, and a securement device, each chisel base slidable relative to the mounting plate.

4. The corner chisel device of claim 3 wherein the securement device surrounds at least a portion of the chisel portion.

5. The corner chisel device of claim 3, and further comprising:
spring means for biasing the chisel portion in a generally upward direction relative to the chisel base.

6. The corner chisel device of claim 5, and further comprising:
means for limiting the extent of travel of the chisel portion in a generally upward direction.

7. A system for chiseling a material from a recess having an edge, the system comprising:
a first chisel base having a first side and a second side;
a first chisel portion associated with the first chisel base and selectively movable to remove material;
a second chisel base having a first side and a second side; and
a second chisel portion associated with the second chisel base and selectively movable to remove material;
wherein at least three of the sides selected from the first side of the first chisel base, the second side of the first chisel base, the first side of the second chisel base, and the second side of the second chisel base are contactable with the edge of the recess for aligning either the first chisel portion or the second chisel portion prior to removing the material.

8. The system of claim 7 wherein the first side of the first chisel base, the second side of the first chisel base, the first side of the second chisel base, and the second side of the second chisel base are contactable with the edge of the recess for aligning the first chisel portion and the second chisel portion prior to removing the material.

9. The system of claim 7, and further comprising:
a handle; and
a mounting base secured to the handle, the first chisel base and the second chisel base being connected to the mounting base.

10. The system of claim 9 wherein the first chisel base and the second chisel base are adjustably slidably secured to the mounting base.

11. The system of claim 7, and further comprising:
a first securement device for securing the first chisel portion to the first chisel base, the first chisel portion slidable between the first securement device and the first chisel base; and
a second securement device for securing the second chisel portion to the second chisel base, the second chisel portion slidable between the second securement device and the second chisel base.

12. The system of claim 11, and further comprising:
spring means for biasing each chisel portion in a generally upward direction relative to the respective chisel base.

13. The system of claim 12, and further comprising:
means for limiting the extent of travel of each chisel portion in a generally upward direction.

14. A method for removing the unchiseled corners of a door hardware receiving area on a door, the method comprising:
aligning a chisel portion within the door hardware receiving area with at least a three-point contact with the door hardware receiving area.

15. The method of claim 14, and further comprising:
providing a first chisel base having a first side and a second side;
slidably securing a first chisel portion to the first chisel base, providing a second chisel base having a first side and a second side;
slidably securing a second chisel portion to the second chisel base;
aligning the first side of the first chisel base, the second side of the first chisel base, and the first side of the second chisel base in contact with an edge of the door hardware receiving area; and
selectively moving either the first chisel portion or the second chisel portion to remove an unchiseled corner from the door;

16. The method of claim 15, and further comprising:
providing a handle;
securing the handle to a mounting base;
securing the first chisel base to the mounting base;
securing the second chisel base to the mounting base; and
selectively and separably operating the first chisel assembly and the second chisel assembly to remove the unchiseled corners of the door hardware receiving area.

17. The method of claim 16, and further comprising:
adjustably slidably securing the first chisel base and the second chisel base to the mounting base.

18. The method of claim 15, and further comprising:
surrounding at least a portion of the chisel portion with a securement device.

19. The method of claim 15, and further comprising:
biasing the chisel portion in a generally upward direction relative to the chisel base.

20. The method of claim 18, and further comprising:
limiting the extent of travel of the chisel portion in a generally upward and downward direction.
